(19) United States
(12) Patent Application Publication
(10) Pub. No.: US 2006/0096820 A1
(43) Pub. Date: May 11, 2006

(54) Suspension system for motor vehicles

(75) Inventor: Hubert Beck, Eitorf (DE)

Correspondence Address: COHEN, PONTANI, LIEBERMAN & PAVANE, 551 FIFTH AVENUE, SUITE 1210, NEW YORK, NY, 10176, US

(73) Assignee: ZF Friedrichshafen AG

(21) Appl. No.: 11/266,449

(22) Filed: Nov. 3, 2005

(30) Foreign Application Priority Data
Nov. 5, 2004 (DE) 102004053401.2-21

(51) Int. Cl. F16F 9/36

(52) U.S. Cl. 188/322.16

(57) ABSTRACT

Suspension system for motor vehicles having at least one piston-cylinder assembly equipped with a working cylinder, a piston rod, and a damping piston with damping valves. A closed envelope of changeable shape is provided as the compensating space, the walls of which include a gas-tight barrier material and which has a connecting element mounted in the piston rod guide, where the connecting element is held in the bore formed in the piston rod guide by a positive connection.

### BACKGROUND OF THE INVENTION

1. Field of the Invention

The invention pertains to a suspension system for motor vehicles.

2. Description of the Related Art

Level-control elements and shock absorbers are already known in which the job of compensating for the volume of the piston rod is performed by an enveloping, gas-filled body. See U.S. Pat. Nos. 6,648,309 and 6,116,585.

The way in which the envelope is filled with gas can be derived from U.S. Pat. No. 6,648,309, but there is no indication of how the envelope can be attached securely and reliably to the piston rod guide. U.S. Pat. No. 6,116,585 describes an envelope but does not discuss the details of how it is attached.

A suspension system for motor vehicles is also known, see U.S. Patent Publication No. 2004/178033, in which an envelope is mounted in the piston rod guide by means of a snap connection. This attachment is characterized by rapid and reliable installation, but if leaks are detected in the course of a leak test after the installation or partial installation of the subassembly consisting of the piston rod guide and the envelope, it is difficult, if not impossible, to recover the individual parts. If leaks are found, the envelope cannot be removed from the piston rod guide without destroying it because of the snap connection.

### SUMMARY OF THE INVENTION

The object of the invention is to provide a suspension system for motor vehicles with a closed envelope of changeable shape which is mounted in the suspension system in such a way that the envelope is held tightly and permanently in the compensating space and is provided with a flow connection which allows the envelope to be filled with gas from an external source in such a way that, if necessary, the envelope can be detached from the piston rod guide.

To achieve this object, a connecting element configured in accordance with the invention is held in a bore of a piston rod guide by a positive connection.

The advantage of this solution is that, because of the positive connection, the connecting element together with the envelope can be easily installed but also easily removed later if a leak is detected when the components in question are tested.

In accordance with another embodiment, a quarter-turn fastener is used as the positive connection. It is advantageous here to provide the connecting element with at least one lobe, which can engage in recesses in a bushing. It is also advantageous that, because of the use of a quarter-turn fastener, which allows the connecting element to be rotated in the piston rod guide, the envelope can first be pushed into a position not intended for operation and then brought into its final position by further rotation. After that, the subassembly can be subjected to a function test, and, if the result is positive, it can be inserted into the working cylinder. Then the entire assembly, including the piston rod guide, is introduced into the housing. After the other components have been installed and the envelope is in its final operating position, the connection cannot come apart.

According to another embodiment, the bore is formed by a bushing.

A favorable embodiment provides that a seal is clamped between a shoulder of the connecting element and a bushing.

A simple method for introducing the fastening components is to mount the bushing nonpositively in the bore. It is advantageous here for the bushing to be held by a press-fit in the bore.

An assembly method for reducing the number of rejects is obtained by designing the subassembly consisting of the piston rod guide and the envelope in such a way that it can be subjected to a function test.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings wherein like reference numerals delineate similar elements throughout the several views:

FIG. 1 shows a cross-section of a self-pumping, hydropneumatic MacPherson strut unit;

FIG. 2 shows a detailed view of an envelope with its connecting element in cross-section on an enlarged scale; and

FIGS. 3-7 show views of the connecting element as a separate part.

### DETAILED DESCRIPTION OF THE PRESENTLY PREFERRED EMBODIMENTS

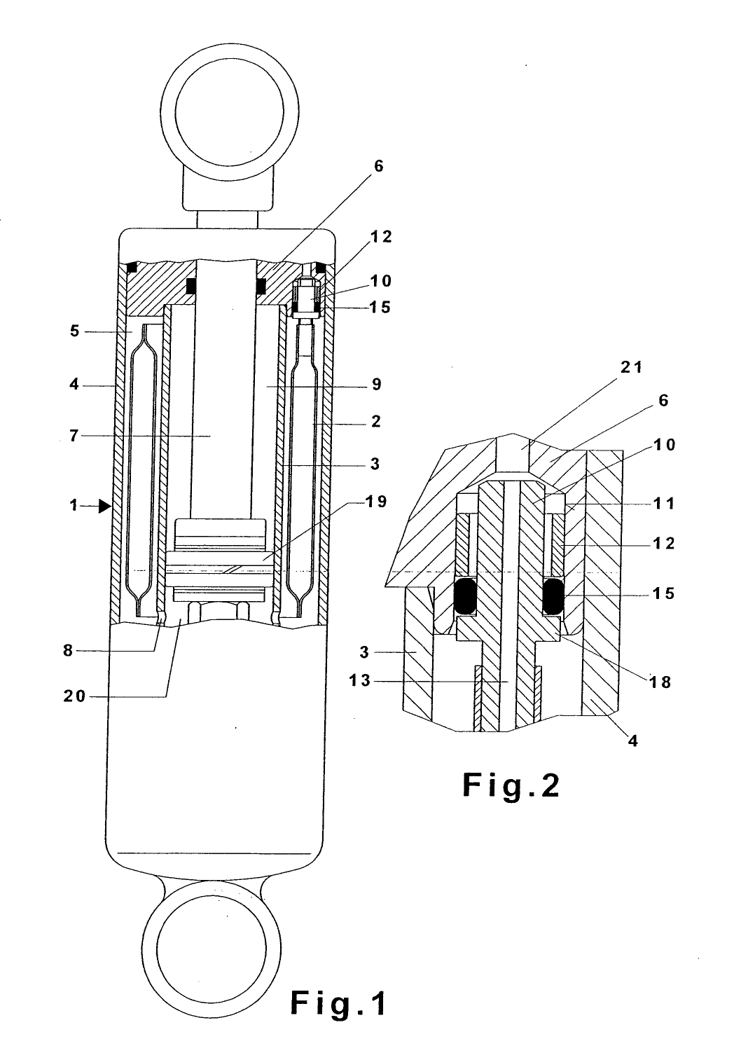

FIG. 1 shows a self-pumping, hydropneumatic MacPherson strut unit, although a vibration damper is also conceivable, consisting of a working cylinder 3, in which a piston 19 is mounted, where an upper working space 9 is formed between the piston 19 and the piston rod guide 6. An outer tube 4, which forms the compensating space 5, extends coaxially around the working cylinder 3.

The piston rod 7, which guides the piston 19, passes through the piston rod guide 6 to the atmosphere. The connecting element 10 of the envelope 2 is also mounted in this piston rod guide 6.

The lower working space 20 is connected to the compensating space 5 by the opening 8.

FIG. 2 shows a detail of the working cylinder 3, which is surrounded by the outer tube 4. The piston rod guide 6 with its bore 11 is installed between the working cylinder 3 and the outer tube 4. The connecting element 10 is held in this bore 11.

A seal 15 is clamped between a bushing 12, which has been pressed into the bore 11, and a shoulder 18 of the connecting element 10. The connecting element 10 has an opening 13, which starts from the interior space of the envelope 2 and leads to the flow connection 21.

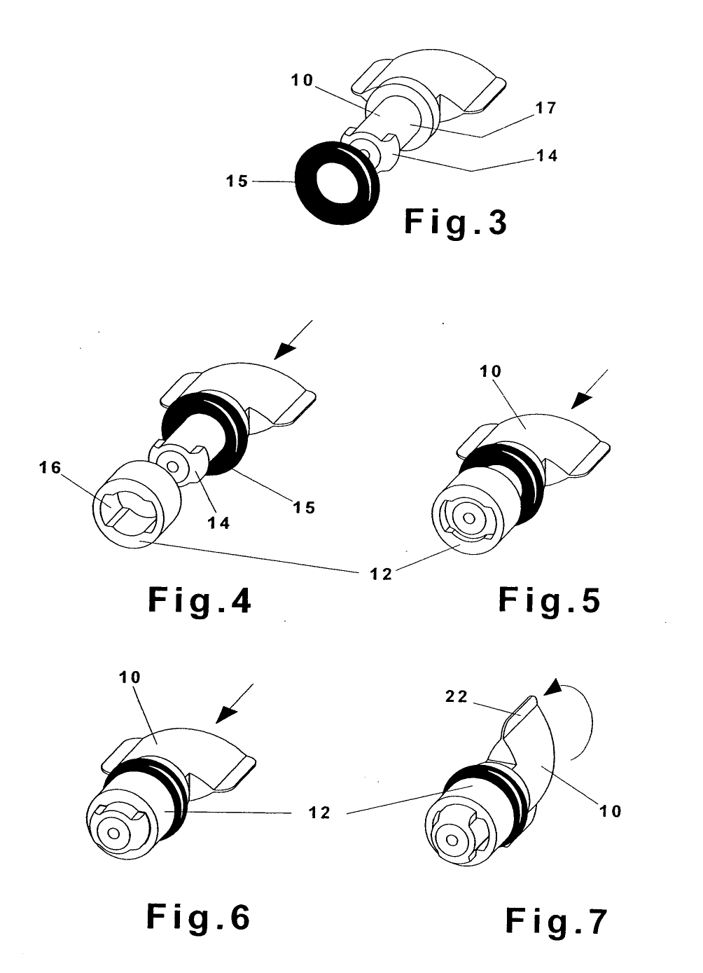

FIGS. 3-7 show detailed views of the connecting element 10, which has lobes 14 serving as part of a rotary joint fastener. The surface 17 serves to hold the seal 15. FIG. 4 also shows the bushing 12, which has recesses 16, the open cross section of which corresponds to the shape of the lobes 14. After the connecting element 10 has been introduced into the bushing 12 as shown in FIG. 5 and then the connecting element 10 is rotated while the bushing 12 remains stationary according to FIGS. 6 and 7, the positive connection in the form of a quarter-turn fastening is created, where simultaneously the seal 15 is pretensioned in the radially outward direction, thus ensuring a seal between the connecting element 10 and the piston rod guide 6. After installation, the elements 22 of the connecting element 10 are located in the compensating space 5 between the working cylinder 3 and the outer tube 4. After final assembly of the level-control element 1 or of the shock absorber, it is no longer possible for any rotation to occur, and thus it is impossible for the envelope 2 to become detached from the piston rod guide 6.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A suspension system for motor vehicles, comprising:
a working cylinder;
a piston rod guide mounted in the working cylinder and having a bore;
a piston rod guidably inserted in the piston rod guide and displaceable through the piston rod guide;
a damping piston coupled to the piston rod so as to move therewith; and
a closed envelope of changeable space configured as a compensating space, the closed envelope comprising:
a wall comprising a gas-tight barrier layer,
a connecting element coupled to the wall of the envelope and insertable into the bore, and
a positive connection coupling the connecting element in the bore.

2. The suspension system of claim 1, wherein the connecting element is configured as a quarter-turn fastener.

3. The suspension system of claim 2, wherein the connecting element comprises a bushing provided with a recess, the positive connection comprising at least one lobe provided on the connecting element and rotatably engaging the recess of the bushing.

4. The suspension system of claim 1, wherein the connecting element has a bushing pressed into the piston rod guide so as to define the bore.

5. The suspension system of claim 1, wherein the connecting element has a shoulder, and the connecting element comprises a bushing inserted into the bore and spaced from the shoulder so as to define a space therewith, and a seal received in the space and clamped between the shoulder and the bushing.

6. The suspension system of claim 4, wherein the bushing is detachably mounted to the bore of the piston rod guide.

7. The suspension system of claim 6, wherein the bushing is press-fit in the bore.

8. The suspension system of claim 1, wherein the piston rod guide and the closed envelope are configured to be tested before being inserted into the working cylinder.

9. The suspension system of claim 1, wherein the damping piston has damping valves.
